(19) United States
(12) Patent Application Publication
(10) Pub. No.: US 2025/0091231 A1
(43) Pub. Date: Mar. 20, 2025

(54) WIRE BODY FIXING STRUCTURE, MACHINE, ROBOT, AND ACTUATOR

(71) Applicant: FANUC CORPORATION, Yamanashi (JP)

(72) Inventor: Kazutaka NAKAYAMA, Yamanashi (JP)

(21) Appl. No.: 18/294,159

(22) PCT Filed: Aug. 26, 2021
(86) PCT No.: PCT/JP2021/031374

§ 371 Date: Feb. 1, 2024

(51) Int. Cl. B25J 19/00; H02G 11/00

(52) U.S. Cl. CPC B25J 19/0029; H02G 11/00

(57) ABSTRACT

This wire body fixing structure comprises an actuator that is provided with a through hole through which a wire body passes, and a fixing part that fixes, in the space inside the through hole, the wire body between the axis of the actuator and the inner surface of the through hole.

### RELATED APPLICATIONS

The present application is a National Phase of International Application No. PCT/JP2021/031374 filed Aug. 26, 2021.

### TECHNICAL FIELD

The present invention relates to a wire body fixing technique for a machine, and particularly to a wire body fixing structure, a machine, a robot, and an actuator.

### BACKGROUND ART

In general, a structure in which wire bodies, such as cables, tubes, or wires, are laid inside a robot mechanism part so that the wire bodies are not entangled with a person is desired for collaborative robots. Further, even in robots other than collaborative robots, a wire body may be laid inside a robot mechanism part so that the wire body does not interfere with an object that is present in a working space of the robots. In an articulation structure of such robots, a technique has been proposed for providing a through-hole at an electric motor, a decelerator, or an actuator such as an electric motor to which a sensor or the like is attached, arranging a protection tube for protecting the wire body inside the through-hole, and inserting the wire body into the protection tube, thereby avoiding that the wire body comes into contact with the actuator, and improving the lifetime of the wire body. On the other hand, a technique has been proposed for laying a wire body in a fixed manner outside an exit of a through-hole.

However, in a rotation shaft structure of a machine, such as a robot, a vehicle, or a construction machine, when the above-described configuration in which a wire body is inserted into a through-hole or a protection tube is employed, a space through which the wire body passes becomes narrow, which limits the number of wire bodies that can be passed though. Particularly in a wrist axis of an articulated robot, the actuator tends to be small and the through-hole tends to be narrow, making it difficult to pass through many wire bodies. In recent years, the number of wire bodies that can be passed through has been increasing as robot tools such as hands and sensors have become more sophisticated.

Further, when a wire body is fixed outside an exit of a through-hole and at locations away from the rotation axis in a radial direction in a rotation shaft structure for a machine, not only a twist stress but also a bending load are applied to the wire body in response to a rotating operation of the machine. Further, when the wire body is fixed outside the exit of the through-hole, a protrusion of the fixing member makes it difficult to make the machine compact in the rotation axis direction. Regarding techniques related to the present application, the documents listed below are known.

Patent literature 1 describes a robot wrist device in which a cable such as a signal line or a power supply line is guided to the inside of a first swivel part swiveling about a fourth axis via a grommet, is then inserted into a first through-hole of a swinging part swinging around a fifth axis, is further inserted into a second through-hole of a second swivel part swiveling about a sixth axis, and is guided via a grommet inside a hand. It is also described that a cable protection tube is fixed to the second swivel part so as to avoid the cable coming into sliding contact with the first through-hole of the swinging part and being damaged even if the cable twists as the second swivel part swivels.

Patent literature 2 describes a robot device including a crankshaft including a hollow part into which a cable is inserted, a first clamp that clamps the cable at a swivel case, and a second clamp that clamps the cable at a support casing, the cable being fixed to the swivel case and the support casing with the first and second clamps so as not to twist when a swivel operation angle is 0 degrees.

Patent literature 3 describes a rotation shaft structure of a robot including a first member, a second member rotatably supported relative to the first member, an actuator that rotationally drives the second member relative to the first member, a sensor that detects a physical quantity acting between an output shaft member of the actuator and the second member, and a fixing member that fixes a wire body, the fixing member being fixed to the output shaft member with a predetermined gap between the fixing member and the sensor.

Patent literature 4 describes a robot drive unit in which a wire body is inserted into a hollow hole of a decelerator, and a first fixing member and a second fixing member that fix the wire body are attached to an end surface of the decelerator and a bracket to which the decelerator and a motor are attached, respectively.

Patent literature 5 describes a robot wrist mechanism in which a control cable covered with a protection tube is partially wound and unwound around a hollow drive shaft, is passed through a pulling-out part formed by cutting out a portion of a flange of the hollow drive shaft, and is secured by a clamp in front of the pulling-out part.

Patent literature 6 describes an industrial robot in which a cable is arranged inside and outside a manipulator through a cable passing hole provided at a side surface of the manipulator, a cable protection tube is provided outside the cable, and a cable protection tube fixing tool that is coupled to one end side of the cable protection tube is provided.

### CITATION LIST

### Patent Literature

PTL 1: Japanese Unexamined Patent Publication No. 2009-125846A

PTL 2: Japanese Unexamined Patent Publication No. 2013-99826A

PTL 3: Japanese Unexamined Patent Publication No. 2021-3787A

PTL 4: Japanese Unexamined Patent Publication No. 2021-84207A

PTL 5: Japanese Unexamined Patent Publication No. 2006-021299A

PTL 6: International Publication No. WO2008/044348A1

### SUMMARY OF INVENTION

### Technical Problem

In view of the problems in the related art, an object of the present invention is to provide a wire body fixing technique capable of maintaining or increasing the number of wire bodies that are passed through while reducing a stress acting on the wire bodies.

### Solution to Problem

An aspect of the present disclosure provides a wire body fixing structure including an actuator provided with a through-hole through which a wire body passes and a fixing part configured to fix the wire body between an axis of the actuator and an inner circumferential surface of the through-hole in an internal space of the through-hole.

Another aspect of the present disclosure provides a machine, a robot, or an actuator including the above-described wire body solid structure.

### Advantageous Effects of Invention

According to an aspect of the present disclosure, a bending stress is not applied to the wire body during an operation of the actuator in contrast to a case where the wire body is fixed at location separated in the radial direction from the axis outside the exits of the through-hole, by fixing the wire body in the internal space of the through-hole. Further, it is possible to reduce a stress acting on the wire body due to twisting of the wire body during an operation of the actuator as compared with a case where the wire body is fixed on the axis of the actuator, by fixing the wire body at positions away from the axis of the actuator by a predetermined distance, the internal space of the through-hole is maximized even when the internal space of the through-hole is narrow, and it is thus possible to maintain or increase the number of wire bodies inserted into the through-hole.

### BRIEF DESCRIPTION OF DRAWINGS

FIG. 1 is a perspective view of a machine including a wire body fixing structure according to a first embodiment.

FIG. 2 is a sectional view of the wire body fixing structure according to the first embodiment.

FIG. 3 is a back view of the wire body fixing structure according to the first embodiment.

FIG. 4 is a front view of the wire body fixing structure according to the first embodiment.

FIG. 5 is a rear-side enlarged sectional view of the wire body fixing structure according to the first embodiment.

FIG. 6 is a front-side enlarged sectional view of the wire body fixing structure according to the first embodiment.

FIG. 7 is a sectional view of a wire body fixing structure according to a second embodiment.

FIG. 8 is a sectional view of a wire body fixing structure according to a third embodiment.

FIG. 9 is a sectional view of a wire body fixing structure according to a fourth embodiment.

### DESCRIPTION OF EMBODIMENTS

Embodiments of the present disclosure will be described in detail below with reference to the accompanying drawings. In the drawings, identical or similar constituent elements are given identical or similar reference signs. Additionally, the embodiments to be described below are not intended to limit the technical scope of the invention or the meaning of terms set forth in the claims. It should be noted that the term “forward” or “front” in the specification refers to an output side or a load side of an actuator while the term “backward” or “rear” refers to a side opposite to the output or the side opposite to the load of the actuator. Further, it should be noted that the term “axis” means a rotation axis in a case of a rotary actuator while the term means a straight axis in the longitudinal direction in a case of a linear actuator.

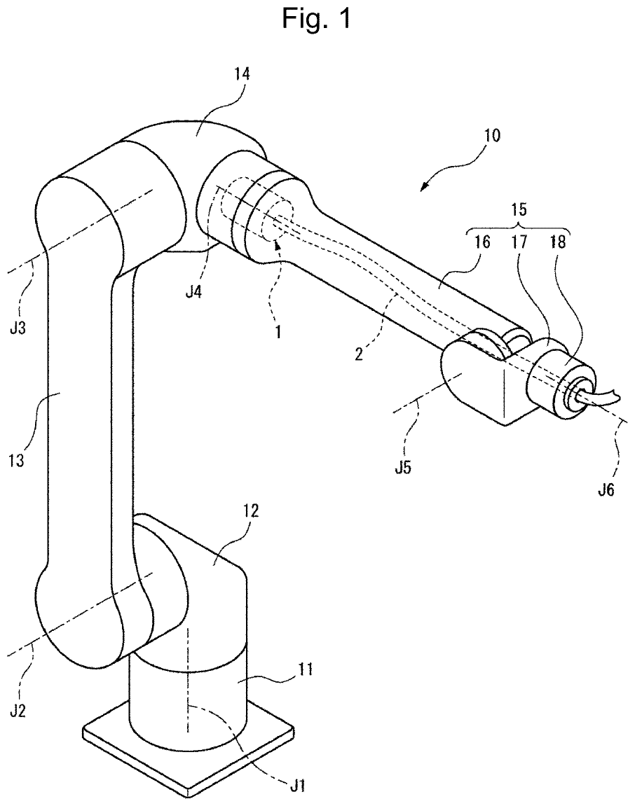

FIG. 1 is a perspective view of a machine 10 including a wire body fixing structure 1 according to a first embodiment. It should be noted that although the machine 10 according to the present embodiment is a robot, the machine 10 may be another machine such as a vehicle or a construction machine in other embodiments. For example, although the machine 10 is an industrial robot (e.g., a collaborative robot) with one or more wire bodies 2 laid therein, the machine 10 also includes a robot in another mode such as a humanoid in other embodiments. It should be noted that although the wire body fixing structure 1 according to the present embodiment is an articulation structure of a robot, the wire body fixing structure 1 may be a rotation shaft structure of a machine such as a vehicle or a construction machine in other embodiments. Although the wire body fixing structure 1 is an articulation structure of a robot at a fourth axis J4, for example, the wire body fixing structure 1 may be an articulation structure of a robot at an axis other than the fourth axis J4, as in the embodiments to be described later.

The machine 10 includes a base 11 and a swivel body 12 rotatably supported relative to the base 11 about a first axis J1. Further, the machine 10 includes a first arm 13 that is rotatably supported relative to the swivel body 12 about a second axis J2 orthogonal to the first axis J1, a second arm 14 (first link) rotatably supported relative to the first arm 13 about a third axis J3 parallel to the second axis J2, and a three-axis wrist unit 15 (second link) attached to a distal end of the second arm 14. Furthermore, although not illustrated, the machine 10 may include a tool to be attached to a distal end of the wrist unit 15. For example, the tool includes a hand, a welding torch, a spot gun, and the like.

The wrist unit 15 includes a first wrist element 16 that is rotatably supported relative to the second arm 14 about the fourth axis J4 orthogonal to the third axis J3, and a second wrist element 17 that is rotatably supported relative to the first wrist element 16 about a fifth axis J5 orthogonal to the fourth axis J4. Furthermore, the wrist unit 15 includes a third wrist element 18 that is rotatably supported relative to the second wrist element 17 about a sixth axis J6 orthogonal to the fifth axis J5.

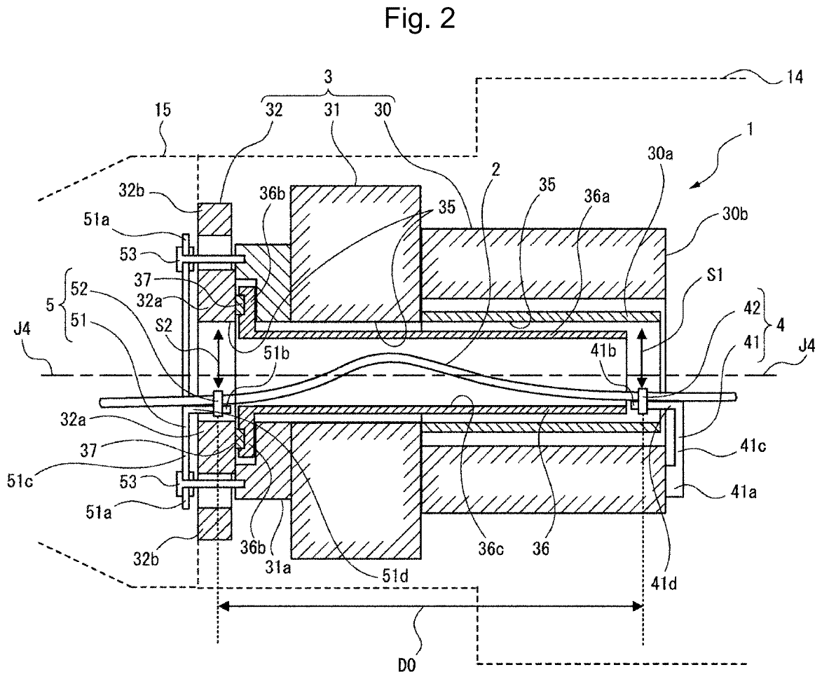

FIG. 2 to FIG. 4 are a sectional view, a rear view, and a front view of the wire body fixing structure 1 according to the first embodiment, respectively. The wire body fixing structure 1 according to the present embodiment includes an actuator 3 including a through-hole 35 through which the wire body 2 passes, and two fixing parts 4 and 5 that fix the wire body 2 in internal spaces S1 and S2 of the through-hole 35, respectively. Furthermore, the wire body fixing structure 1 according to the present embodiment includes a protection tube 36 that protects the wire body 2 from power transmission elements of the actuator 3. For ease of understanding, it should be noted that although the fixing parts 4 and 5 according to the present embodiment fix only one wire body 2, the fixing parts 4 and 5 fix multiple wire bodies 2 in general or in other embodiments. The wire body 2 includes, for example, a cable, a tube, and a wire for operating the wrist unit 15, a tool, or the like.

The actuator 3 according to the present embodiment rotates the wrist unit 15 (second link) relative to the second arm 14 (first link) about the fourth axis J4. The actuator 3 according to the present embodiment includes an electric motor 30, a decelerator 31, and a sensor 32. The electric motor 30 is configured with a known motor, for example, the decelerator 31 is configured with a known gear mechanism, and the sensor 32 is configured with a known torque sensor, for example. The electric motor 30 is fixed to the second arm 14 (first link), an output shaft 30a of the electric motor 30 is coupled to an input part (not illustrated; e.g., an input gear) of the decelerator 31, an output part 31a (e.g., an output shaft or a case) of the decelerator 31 is fixed to the sensor 32, and the sensor 32 is fixed to the wrist unit 15 (second link).

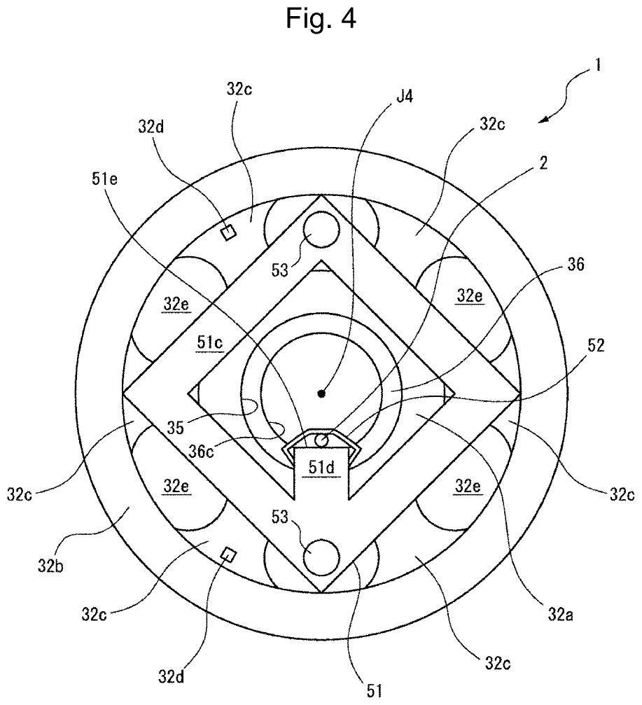

Once the output shaft 30a of the electric motor 30 rotates, the output part 31a of the decelerator 31 rotates at a speed lower than the rotation rate of the output shaft 30a of the electric motor 30, and the output part 31a of the decelerator 31, the sensor 32, and the wrist unit 15 integrally rotate. As illustrated in FIG. 2 and FIG. 4, the sensor 32 according to the present embodiment includes an inner race 32a fixed to the output part 31a of the decelerator 31, an outer race 32b fixed to the wrist unit 15 (second link), a plurality of beam parts 32c connecting the inner race 32a and the outer race 32b, and a strain gauge 32d attached to at least one of the beam parts 32c. The sensor 32 converts the amount of strain (amount of twisting) generated at the beam part 32c into the amount of electricity (e.g., a voltage value) and detects a torque around the shaft of the actuator 3 (the fourth axis J4 in the present embodiment).

The actuator 3 includes a through-hole 35 through which the wire body 2 passes. The through-hole 35 according to the present embodiment passes through all the electric motor 30, the decelerator 31, and the sensor 32. The rear fixing part 4 fixes the wire body 2 in a rear internal space S1 of the through-hole 35, and the front fixing part 5 fixes the wire body 2 in the front internal space S2 of the through-hole 35. To be more specific, the rear fixing part 4 fixes the wire body 2 in the internal space S1 of the electric motor 30 at a position away from the axis (the fourth axis J4 in the present embodiment) of the electric motor 30, and the front fixing part 5 fixes the wire body 2 in the internal space S2 of the sensor 32 at a position away from the axis (the fourth axis J4 in the present embodiment) of the sensor 32. The two fixing parts 4 and 5 include support members 41 and 51 for supporting the wire body 2 and attachment tools 42 and 52 for attaching the wire body 2 to the support members 41 and 51, respectively. The support members 41 and 51 are configured with a bracket formed of a rigid material such as a metal, for example, and the attachment tools 42 and 52 are configured with a clamp formed of a flexible material such as a resin, for example. The support members 41 and 51 include, for example, a L-shaped bracket or a U-shaped bracket, and the attachment tools 42 and 52 include, for example, a binding band, a C-shaped clamp, a U-bolt, or the like. The attachment tools 42 and 52 may be of a type in which the wire body 26 is wrapped with a protection elastic body and the outer periphery thereof is bound directly to the support members 41 and 51 with a nylon band.

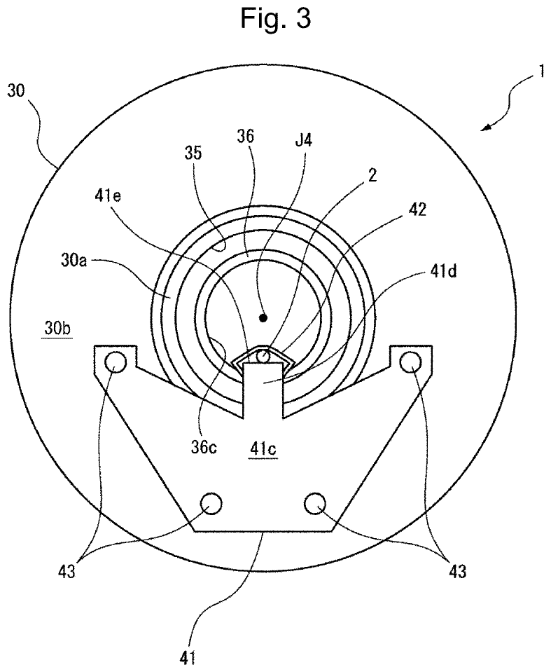

As illustrated in FIG. 2 and FIG. 3, the rear support member 41 according to the present embodiment includes a fixed end 41a that is fixed to a rear portion of a housing 30b of the electric motor 30 with a fastening tool 43 such as a screw, and a free end 41b that is arranged in the rear internal space S1 of the through-hole 35. Further, the rear support member 41 includes a main body part 41c including the fixed end 41a and an L-shaped part 41d extending in an L shape from the main body part 41c to the free end 41b. Although the embodiment is not limited thereto, the main body part 41c preferably includes a plurality of fixed ends 41a extending in the circumferential direction of the through-hole 35 so as not to be bent by a load of the wire body 2. The plurality of fixed ends 41a are fixed to the housing 30b of the electric motor 30 with a plurality of fastening tools 43. The L-shaped part 41d includes a support surface 41e for supporting the wire body 2. The support surface 41e faces the axis (the fourth axis J4 in the present embodiment) of the actuator 3. The rear attachment tool 42 according to the present embodiment attaches the wire body 2 to the support surface 41e in the rear internal space S1 of the through-hole 35.

As illustrated in FIG. 2 and FIG. 4, the front support member 51 according to the present embodiment includes a fixed end 51a that is fixed to the output part 31a of the decelerator 31 with a fastening tool 53 such as a screw, and a free end 51b that is arranged in the front internal space S2 of the through-hole 35. The fastening tool 53 and the fixed end 51a are fixed to the output part 31a through a clearance 32e of the sensor 32 without coming into contact with the sensor 32 so as not to affect torque detection performance of the sensor 32. Further, the front support member 51 includes a main body part 51c including the fixed end 51a and an L-shaped part 51d extending in an L shape from the main body part 51c and extending up to the free end 51b. Although the embodiment is not limited thereto, the main body part 51c preferably includes a plurality of fixed ends 51a extending in the circumferential direction of the through-hole 35 so as not to be bent by the load of the wire body 2. The plurality of fixed ends 51a are fixed to the output part 31a of the decelerator 31 with a plurality of fastening tools 53. The L-shaped part 51d includes a support surface 51e that supports the wire body 2. The support surface 51e faces the axis (the fourth axis J4 in the present embodiment) of the actuators 3. The front attachment tool 42 according to the present embodiment attaches the wire body 2 to the support surface 51e in the front internal space S2 of the through-hole 35.

When the two fixing parts 4 and 5 fix the wire body 2 in the internal space near the middle of the through-hole 35 rather than in the internal spaces S1 and S2 in the vicinity of the exits of the through-hole 35, respectively, a distance DO between the rear attachment tool 42 and the front attachment tool 52 is relatively short, and the wire body 2 is thus further twisted. However, since the two fixing parts 4 and 5 according to the present embodiment fix the wire body 2 in the internal spaces S1 and S2 in the vicinity of the exits of the through-hole 35, respectively, the distance DO between the rear attachment tool 42 and the front attachment tool 52 is relatively long, and the twisting of the wire body 2 can thus be reduced.

Further, when the two fixing parts 4 and 5 respectively fix the wire body 2 not in the internal spaces S1 and S2 of the through-hole 35 but outside the exit of the through-hole 35 and away from the axis of the actuator 3 in the radial direction, not only a twisting stress but also a bending stress is applied to the wire body 2 during an operation of the actuator 3. However, since the two fixing parts 4 and 5 according to the present embodiment fix the wire body 2 in the internal spaces S1 and S2 of the through-hole 35, respectively, a bending stress is less likely to act on the wire body 2 during an operation of the actuator 3.

Furthermore, when the two fixing parts 4 and 5 fix the wire body 2 on the axis of the actuator 3 rather than between the axis (the fourth axis J4 in the present embodiment) of the actuator 3 and the inner circumferential surface of the through-hole 35, respectively, a twisting stress on the wire body 2 is relatively increased during an operation of the actuator 3. However, since the two fixing parts 4 and 5 according to the present embodiment fix the wire body 2 at positions away from the axis of the actuator 3 by a predetermined distance, respectively, it is possible to reduce the twisting stress on the wire body 2 accordingly during an operation of the actuator 3.

Further, in particular, although the articulation structure of the robot at the fourth axis J4, is smaller than the articulation structures of the robots at the other axes, such as the first axis J1 to the third axis J3 and the like, and with this, the internal spaces S1 and S2 of the through-hole 35 tend to become narrow. The two fixing parts 4 and 5 according to the present embodiment fix the wire body 2 at the positions away from the fourth axis J4, respectively, and it is thus possible to maximize the internal spaces S1 and S2 of the through-hole 35 even when the internal space of the through-hole 35 is narrow and to maintain or increase the number of wire bodies 2 inserted into the through-hole 35.

Further, although the actuator 3 rotates forward or backward the wrist unit 15 (second link) relatively to the second arm 14 (first link) by 180 degrees from the reference position of the actuator 3, when the two fixing parts 4 and 5 (the two attachment tools 42 and 52) fix the wire body 2 at the angular positions deviating from each other by 45 degrees or at angular positions deviating from each other by 60 degrees from each other about the axis of the actuator 3, for example, without fixing the wire body 2 at the substantially same angular positions with respect to each other or at angular positions deviating from each other by approximately 180 degrees about the axis of the actuator 3 at the reference position of the actuator 3, there is a likelihood that the wire body 2 has already been twisted at the reference position of the actuator 3, and the wire body 2 is further twisted during an operation of the actuator 3. However, since the two fixing parts 4 and 5 according to the present embodiment fix the wire body 2 at the substantially same angular positions with respect to each other or at the angular positions deviating from each other by approximately 180 degrees about the axis of the actuator 3 at the reference position of the actuator 3, it is possible to reduce twisting of the wire body 2 during an operation of the actuator 3. Further, when the wire body is passed through the through-hole, it is easier to pass the wire body therethrough straightly at the reference position of the actuator 3.

Since a pulling force acts on the wire body 2 every time the actuators of the other coupling parts (the other articulation parts of the robot in the present embodiment) of the machine 10 operate, it is preferable that the wire body 2 be laid loosely with a predetermined amount between the two fixing parts 4 and 5 (two attachment tools 42 and 52) and at least one selected from the group of the support surfaces 41e and 51e of the support members 41 and 51 supporting the wire body 2 and contact surfaces of the attachment tools 42 and 52 with the wire body 2 be smoothed so that the wire body 2 is not disconnected due to friction with the support members 41 and 51 or the attachment tools 42 and 52. The “predetermined amount” is a difference between the length between the two fixing parts 4 and 5 when the wire body is straightened and the length between the two fixing parts 4 and 5 when the wire body is loosened, or in the predetermined amount, it may be a radius of curvature of the loosening. The predetermined amount may be determined in advance by conducting an experiment in which all coupling parts of the machine 10 are operated. For example, the support surfaces 41e and 51e and the contact surfaces of the attachment tools 42 and 52 are preferably formed smoothly with a resin or are preferably applied with a lubricant such as a lubricant oil or a grease. An improvement in lifetime of the wire body can also be expected when a grease is applied to the entire movable parts of the wire body.

Further, the wire body 2 according to the present embodiment is inserted into the hollow hole 36c of the protection tube 36, and the protection tube 36 protects the wire body 2 from power transmission elements of the actuator 3. Since the wire body 2 is fixed to the output part 31a of the decelerator 31 with the front fixing part 5, and the wire body 2 rotates forward or backward by 180 degrees integrally with the output part 31a of the decelerator 31, the sensor 32, and the wrist unit 15. However, when the actuator 3 includes the decelerator 31 as described in the present embodiment, the rotation rate of the output shaft 30a of the electric motor 30 is much larger than the rotation rate of the output part 31a of the decelerator 31, and thus the wire body 2 may come into contact with the power transmission elements of the actuator 3, such as the output shaft 30a of the electric motor 30 and the input part (e.g., an input gear) of the decelerator 31, inside the through-hole 35 and may be damaged and disconnected. Therefore, the protection tube 36 protects the wire body 2 from the power transmission elements of the actuator 3.

The protection tube 36 is a tubular member with a flange formed of a resin, for example. The length of the protection tube 36 is shorter than the length of the through-hole 35, and the protection tube 36 is arranged inside the through-hole 35. The protection tube 36 includes a tubular part 36a and a flange part 36b extending in the radial direction from the tubular part 36a. The flange part 36b of the protection tube 36 according to the present embodiment is sandwiched between the output part 31a (first member) of the decelerator 31 and the sensor 32 (second member). When the flange part 36b is fixed to the output part 31a of the decelerator 31 with a fastening tool such as a screw, the size of the actuator 3 in the axial direction increases by the amount corresponding to the screw head portion, but it is possible to reduce the size of the actuator 3 in the axial direction by sandwiching the flange part 36b between the first member and the second member as described in the present embodiment.

Further, the wire body fixing structure 1 further includes an elastic body 37 inserted between the flange part 36b of the protection tube 36 and the sensor 32. For example, the elastic body 37 is configured with an O ring formed of an elastic material such as an elastomer, for example. Although the embodiment is not limited thereto, the elastic body 37 is accommodated in a ring-shaped recessed part formed in the flange part 36b of the protection tube 36. The elastic body 37 preferably protrudes forward in the axial direction from the flange part 36b and increases a frictional force with the sensor 32 by coming into surface contact with the sensor 32. In other words, the vertical section of the elastic body 37 preferably has a rectangular shape. Further, preferably, only the elastic body 37 with a relatively high frictional coefficient comes into contact with the inner race 32a of the sensor 32, and the flange part 36b of the protection tube 36 with a relatively low frictional coefficient does not come into contact with the inner race 32a of the sensor 32. When the inner race 32a of the sensor 32 is fixed to the output part 31a of the decelerator 31, the elastic body 37 is compressed between the inner race 32a of the sensor 32 and the flange part 36b of the protection tube 36, the flange part 36b of the protection tube 36 is pressed against the end surface of the output part 31a of the decelerator 31 due to a restoring force of the elastic body 37, and the protection tube 36 is thereby sandwiched between the output part 31a of the decelerator 31 and the sensor 32.

Only the elastic body 37 with a relatively high frictional coefficient comes into contact with the inner race 32a of the sensor 32, and the flange part 36b of the protection tube 36 is pressed against the end surface of the output part 31a of the decelerator 31 due to the restoring force of the elastic body 37, so that the protection tube 36 rotates integrally with the output part 31a of the decelerator 31 and the sensor 32 without deviating in the circumferential direction relative to the sensor 32 during an operation of the actuator 3. When the protection tube 36 deviates in the circumferential direction relative to the sensor 32, torque detection performance of the sensor 32 may be affected, but the protection tube 36 does not affect the torque detection performance of the sensor 32 of the present embodiment since the protection tube 36 rotates integrally with the sensor 32. Further, the elastic body 37 comes into surface contact with the inner race 32a of the sensor 32, and the flange part 36b of the protection tube 36 is pressed against the end surface of the output part 31a of the decelerator 31 due to the restoring force of the elastic body 37, so that the protection tube 36 and the elastic body 37 also have the secondary effect of increasing the water resistance on the front side of the actuator 3.

Further, the flange part 36b of the protection tube 36 extends perpendicularly to the tubular part 36a, and the flange part 36b comes into surface contact with the end surface of the output part 31a of the decelerator 31, so that the tubular part 36a extends in parallel to the axis (fourth axis J4) of the actuator 3. As a result, the tubular part 36a of the protection tube 36 is unlikely to come into contact with the power transmission elements of the actuator 3 such as the output shaft 30a of the electric motor 30 and the input part (e.g., an input gear) of the decelerator 31 inside the through-hole 35.

Since the length of the protection tube 36 is shorter than the length of the through-hole 35, the two fixing parts 4 and 5 fix the wire body 2 inside the internal spaces S1 and S2 of the through-hole 35 outside the exit of the protection tube 36, respectively. The front fixing part 5 rotates integrally with the protection tube 36 since the front fixing part 5 is fixed to the output part 31a of the decelerator 31, while the rear fixing part 4 does not rotate integrally with the protection tube 36 since the rear fixing part 4 is fixed to the rear portion of the housing 30b of the electric motor 30. The rear fixing part 4 is arranged as will be described later in the internal space S1 of the through-hole 35, so as not to damage the wire body 2 fixed with the rear fixing part 4 by coming into contact with the protection tube 36 rotating during an operation of the actuator 3.

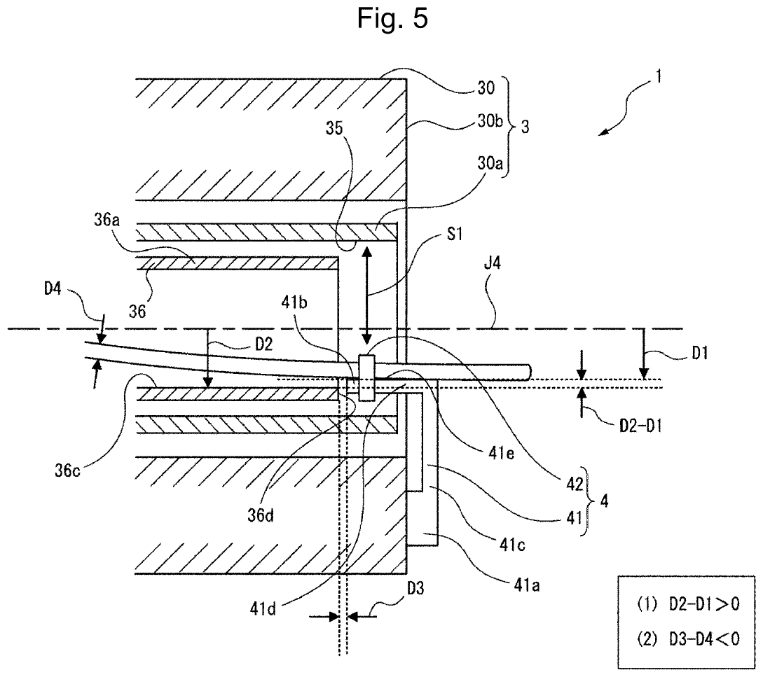

FIG. 5 is a rear enlarged sectional view of the wire body fixing structure 1 according to the first embodiment. The support member 41 of the rear fixing part 4 is arranged such that the distance D1 from the axis (the fourth axis J4 in the present embodiment) of the actuator 3 to the support surface 41e of the support member 41 is shorter than the distance D2 from the axis of the actuator 3 to the inner circumferential surface of the hollow hole 36c of the protection tube 36 (i.e., D2−D1>0). As a result, the wire body 2 does not come into contact with the protection tube 36 rotating during an operation of the actuator 3, and it is thus possible to prevent damage or disconnection of the wire body 2.

Further, the support member 41 of the rear fixing part 4 is preferably arranged such that the distance D3 from the free end 41b of the support member 41 to the end surface 36d of the protection tube 36 is shorter than the thickness of the wire body 2 or the thickness D4 of a bundle of wire bodies 2 (i.e., D3−D4<0) at the rear fixing part 4. As a result, since the wire body 2 does not come into contact with the rotating protection tube 36 during an operation of the actuator 3 and is not caught between the end surface 36d of the protection tube 36 and the free end 41b of the support member 41, damage or disconnection of the wire body 2 can be prevented. Further, the corner of the free end 41b of the support member 41 on the side close to the wire body 2 is preferably rounded so as to prevent the loosened wire body 2 from being damaged even if the wire body 2 comes into contact with the free end 41b of the support member 41.

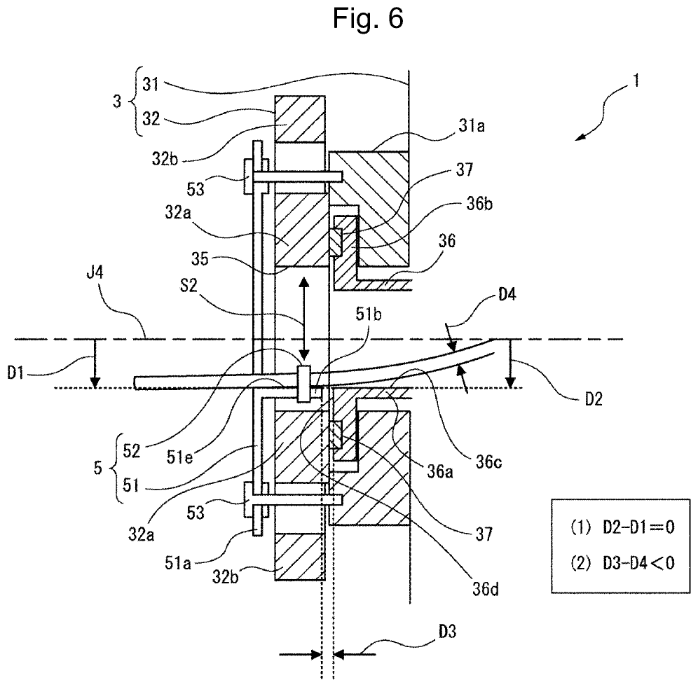

FIG. 6 is a front enlarged sectional view of the wire body fixing structure 1 according to the first embodiment. Since the front fixing part 5 is fixed to the output part 31a of the decelerator 31 and rotates integrally with the protection tube 36 unlike the rear fixing part 4, the support member 51 of the front fixing part 5 may be provided such that the distance D1 from the axis (the fourth axis J4 in the present embodiment) of the actuator 3 to the support surface 51e of the support member 51 is substantially equal to the distance D2 from the axis of the actuator 3 to the inner circumferential surface of the hollow hole 36c of the protection tube 36 (i.e., D2−D1=0). As a result, the number of wire bodies 2 inserted into the hollow hole 36c of the protection tube 36 can be maintained or increased even when the hollow hole 36c of the protection tube 36 is narrow.

Similarly to the rear fixing part 4, the support member 51 of the front fixing part 5 may be arranged such that the distance D3 from the free end 51b of the support member 51 to the end surface 36d of the protection tube 36 is shorter than the thickness of the wire body 2 or the thickness D4 of the bundle of the wire bodies 2 even at the front fixing part 5 (i.e., D3−D4<0). As a result, the wire body 2 does not enter between the end surface 36d of the protection tube 36 and the free end 51b of the support member 51 and does not come into contact with the sensor 32, and it is thus possible to suppress an influence on torque detection performance of the sensor 32 due to contact between the wire body 2 and the sensor 32.

As described above, according to the wire body fixing structure 1 of the first embodiment, by fixing the wire body 2 in the internal spaces S1 and S2 of the through-hole 35, a bending stress is less likely to act on the wire body 2 and only a twisting stress acts thereon during an operation of the actuator 3 as compared with a case where the wire body 2 is fixed outside the exit of the through-hole 35. Further, it is possible to reduce twisting of the wire body 2 during an operation of the actuator 3 as compared with a case where the wire body 2 is fixed on the axis of the actuator 3 by fixing the wire body 2 at positions away from the axis (the fourth axis J4 in the present embodiment) of the actuator 3, and it is possible to maintain or increase the number of wire bodies 2 inserted into the through-hole 35 even when the internal space of the through-hole 35 is narrow.

Hereinafter, modification examples of the wire body fixing structure 1 according to the first embodiment will be described. Although the actuator 3 according to the first embodiment rotates the wrist unit 15 (second link) relative to the second arm 14 (first link) about the fourth axis J4, the actuator 3 may rotate the first arm 13 (second link) relative to the swivel body 12 (first link) around the second axis J2 as in the fourth embodiment to be described later. Further, the actuator 3 in other embodiments may rotate the second arm 14 relative to the first arm 13 (first link) about the third axis J3. In other words, the wire body fixing structure 1 can be applied to any rotation shaft structure of the machine 10.

Further, the actuator 3 according to the first embodiment includes the electric motor 30, the decelerator 31, and the sensor 32, but it may include an electric motor 30 coupled with at least one selected from the group of the decelerator 31, the sensor 32, and another machine element coupled as in a second embodiment, a third embodiment, and a fourth embodiment, which will be described later. Further, the actuator 3 in other embodiments may include only the electric motor 30. Further, the actuator 3 according to the first embodiment is a rotary actuator, but it may be a linear actuator in other embodiments.

Further, the through-hole 35 of the actuator 3 according to the first embodiment passes through all the electric motor 30, the decelerator 31, and the sensor 32, but it may pass through at least one selected from the group of the electric motor 30, the decelerator 31, the sensor 32, and another machine element as in the second embodiment, the third embodiment, or the fourth embodiment, which will be described later.

Further, the wire body fixing structure 1 according to the first embodiment includes the two fixing parts 4 and 5, but it may include any one fixing part out of the two fixing parts 4 and 5 in other embodiments. Further, at least one of the two fixing parts 4 and 5 may fix the wire body 2 inside the internal space S1 or S2 of the through-hole 35 and the other may fix the wire body 2 in an external space of the through-hole 35 as in the third embodiment or the fourth embodiment, which will be described later. Further, at least one of the two fixing parts 4 and 5 may be fixed to the first link (e.g., the second arm 14 or the swivel body 12) or the second link (e.g., the wrist unit 15 or the first arm 13) rather than the actuator 3 as in the second embodiment, the third embodiment, or the fourth embodiment, which will be described later.

Further, the wire body fixing structure 1 according to the first embodiment includes the protection tube 36, but it may not include the protection tube 36 when the actuator 3 does not include the decelerator 31 as in the second embodiment to be described later. Further, the flange part 36b of the protection tube 36 according to the first embodiment is sandwiched between the output part 31a (first member) of the decelerator 31 and the sensor 32, but it may be sandwiched between the first member (the output part 31a of the decelerator 31) and the second member (the wrist unit 15, the first arm 13, or the like) when the actuator 3 does not include the sensor 32 as in the third embodiment or the fourth embodiment, which will be described later. Further, the wire body fixing structure 1 may include at least one selected from the group of the first link (e.g., the second arm 14 or the swivel body 12) and the second link (e.g., the wrist unit 15 or the second arm 14) as in the second embodiment, the third embodiment, or the fourth embodiment, which will be described later.

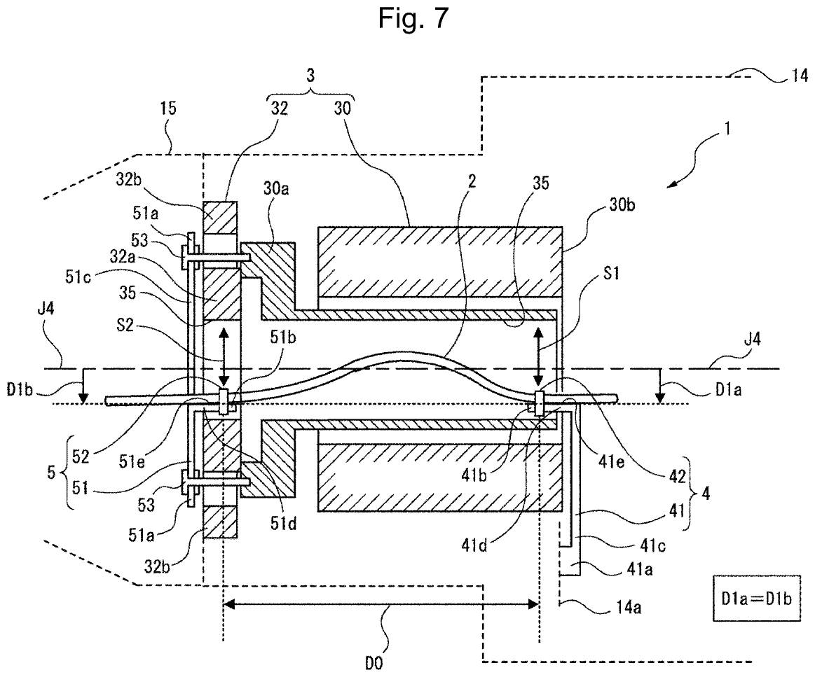

FIG. 7 is a sectional view of a wire body fixing structure 1 according to the second embodiment. An actuator 3 according to the second embodiment is different from the wire body fixing structure 1 according to the first embodiment in that it does not include a decelerator 31 and includes only an electric motor 30 and a sensor 32. The sensor 32 is fixed to an output shaft 30a of the electric motor 30. Also, a front fixing part 5 is also fixed to the output shaft 30a of the electric motor 30. The output shaft 30a of the electric motor 30, the sensor 32, and a wrist unit 15 (second link) integrally rotate. A through-hole 35 of the actuator 3 passes through only the electric motor 30 and the sensor 32.

Since the actuator 3 according to the second embodiment does not include the decelerator 31, the rotation rate of the output shaft 30a of the electric motor 30 does not become excessively larger than the rotation rate of the output part 31a of the decelerator 31. The output shaft 30a of the electric motor 30 and the sensor 32 only rotate forward or backward by 180 degrees during an operation of the actuator 3, and thus the wire body fixing structure 1 according to the second embodiment does not include a protection tube 36. However, since a rear fixing part 4 does not rotate integrally with the output shaft 30a of the electric motor 30 and the sensor 32, the wire body 2 is fixed between an axis (a fourth axis J4 in the present embodiment) of the actuator 3 and an inner circumferential surface of the through-hole 35 in a rear internal space S1 of the through-hole 35 such that the wire body 2 is not damaged by coming into contact with the output shaft 30a of the electric motor 30 during an operation of the actuator 3. To be more specific, the rear fixing part 4 fixes the wire body 2 at a position away from the axis (the fourth axis J4 in the present embodiment) of the electric motor 30 in the internal space S1 of the electric motor 30.

On the other hand, since the front fixing part 5 rotates integrally with the output shaft 30a of the electric motor 30 and the sensor 32, the wire body 2 is not damaged by coming into contact with the output shaft 30a of the electric motor 30 during an operation of the actuator 3. However, the front fixing part 5 fixes the wire body 2 between the axis (the fourth axis J4 in the present embodiment) of the actuator 3 and the inner circumferential surface of the through-hole 35 in the front internal space S2 of the through-hole 35. To be more specific, the front fixing part 5 fixes the wire body 2 at a position away from the axis (the fourth axis J4 in the present embodiment) of the sensor 32 in the internal space S2 of the sensor 32. In this manner, it is possible to reduce twisting of the wire body 2 during an operation of the actuator 3 as compared with a case where the wire body 2 is fixed on the axis of the actuator 3, and the internal spaces S1 and S2 of the through-hole 35 is maximized even when the internal space of the through-hole 35 is narrow. Thus it is possible to maintain or increase the number of wire bodies 2 inserted into the through-hole 35.

Further, a distance D1a from the axis (the fourth axis J4 in the present embodiment) of the actuator 3 to the support surface 41e of the rear support member 41 is preferably substantially equal to a distance D1b from the axis of the actuator 3 to the support surface 51e of the front support member 51 (i.e., D1a=D1b) in order to set substantially the same number of wire bodies 2 inserted into the through-hole 35 in the internal spaces S1 and S2 of the through-hole 35.

Further, the wire body fixing structure 1 according to the second embodiment is also different from the wire body fixing structure 1 according to the first embodiment in that the rear fixing part 4 is fixed to the inside 14a of the second arm 14 (first link) rather than the rear portion of the housing 30b of the electric motor 30. In other words, the rear fixing part 4 is not necessarily fixed to the actuator 3. The support member 41 of the rear fixing part 4 is fixed to the inside 14a of the second arm 14 with a fastening tool 43 such as a screw. On the other hand, the front fixing part 5 is fixed to the output shaft 30a of the electric motor 30 without coming into contact with the sensor 32 so as not to affect torque detection performance of the sensor 32. Since the rear fixing part 4 is fixed to the second arm 14, the wire body fixing structure 1 according to the second embodiment may further include a second arm 14 (first link).

As described above, according to the wire body fixing structure 1 of the second embodiment, a bending stress is not applied to the wire body 2 during an operation of the actuator as compared with a case where the wire body 2 is fixed outside the exit of the through-hole 35, by fixing the wire body 2 in the internal spaces S1 and S2 of the through-hole 35 even when the actuator 3 does not include the decelerator 31. Further, it is possible to reduce twisting of the wire body 2 during an operation of the actuator 3 as compared with a case where the wire body 2 is fixed on the axis of the actuator 3, by fixing the wire body 2 at positions away from the axis (the fourth axis J4 in the present embodiment) of the actuator 3, and the internal spaces S1 and S2 of the through-hole 35 are maximized even when the internal space of the through-hole 35 is narrowed. Thus it is possible to maintain or increase the number of wire bodies 2 inserted into the through-hole 35.

Further, since the distance D1a from the axis (the fourth axis J4 in the present embodiment) of the actuator 3 to the support surface 41e of the rear support member 41 is substantially equal to the distance D1b from the axis of the actuator 3 to the support surface 51e of the front support member 51 (i.e., D1a=D1b), the number of wire bodies 2 inserted into the through-hole 35 is substantially the same in the internal spaces S1 and S2 of the through-hole 35.

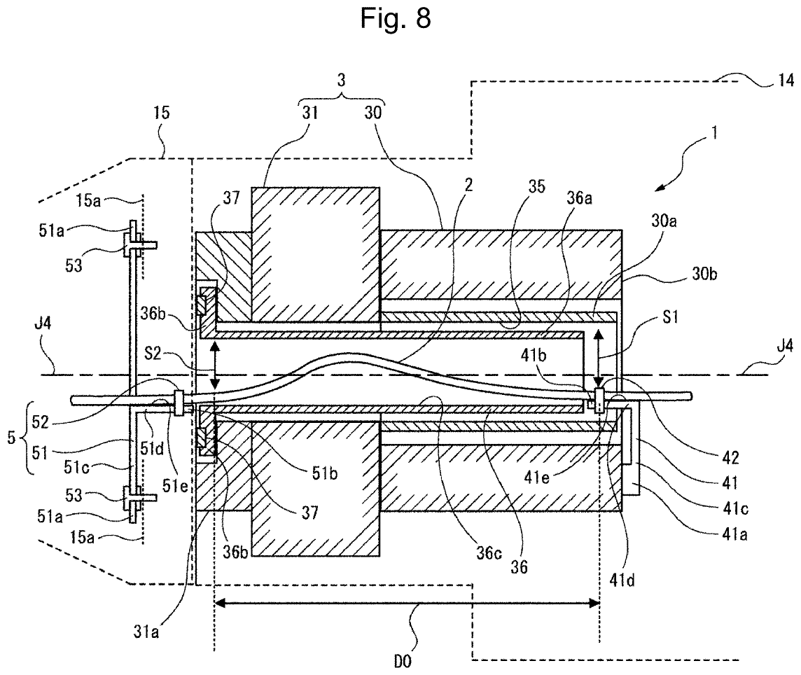

FIG. 8 is a sectional view of a wire body fixing structure 1 according to the third embodiment. An actuator 3 according to the third embodiment is different from the wire body fixing structure 1 according to the first embodiment in that the actuator 3 according to the third embodiment does not include a sensor 32 and includes only an electric motor 30 and a decelerator 31. An output part 31a of the decelerator 31 is fixed to a wrist unit 15 (second link). Further, a flange part 36b of a protection tube 36 is sandwiched between the output part 31a (first member) of the decelerator 31 and the wrist unit 15 (second member). An elastic body 37 is inserted between the flange part 36b of the protection tube 36 and the wrist unit 15 (second member). The output part 31a of the decelerator 31, the protection tube 36, and the wrist unit 15 (second link) rotate integrally. A through-hole 35 of the actuator 3 passes through only the electric motor 30 and the decelerator 31.

A rear fixing part 4 fixes a wire body 2 between an axis (a fourth axis J4 in the present embodiment) of the actuator 3 and an inner circumferential surface of the through-hole 35 in a rear internal space S1 of the through-hole 35 similarly to the wire body fixing structure 1 according to the first embodiment. To be more specific, the rear fixing part 4 fixes the wire body 2 at a position away from the axis (the fourth axis J4 in the present embodiment) of the electric motor 30 in the internal space S1 of the electric motor 30. In other words, the rear fixing part 4 fixes the wire body 2 in the internal space S1 of the through-hole 35 outside the exit of the protection tube 36.

On the other hand, since the front internal space S2 of the through-hole 35 is occupied by the protection tube 36, the front internal space S2 is narrower than the rear internal space S1 of the through-hole 35. Thus, the wire body fixing structure 1 according to the third embodiment is also different from the wire body fixing structure 1 according to the first embodiment in that the front fixing part 5 fixes the wire body 2 in the internal space of the wrist unit 15 (second link) outside the exit of the through-hole 35 rather than the internal space of the through-hole 35. To be more specific, the front fixing part 5 fixes the wire body 2 at a position away from the axis (the fourth axis J4 in the present embodiment) of the wrist unit 15 in the internal space of the wrist unit 15.

The support member 51 of the front fixing part 5 is fixed to the inside 15a of the wrist unit 15 with a fastening tool 53 such as a screw. Although the rear fixing part 4 is fixed to the actuator 3, the front fixing part 5 may not necessarily be fixed to the actuator 3. Since the front fixing part 5 is fixed to the wrist unit 15, the wire body fixing structure 1 according to the third embodiment may further include the wrist unit 15 (second link).

As described above, according to the wire body fixing structure 1 of the third embodiment, the two fixing parts 4 and 5 fix the wire body 2 at the positions away from the axis (the fourth axis J4 in the present embodiment) of the actuator 3 similarly to the wire body fixing structure 1 according to the first embodiment even when the actuator 3 does not include the sensor 32, it is thus possible to reduce twisting of the wire body 2 during an operation of the actuator as compared with a case where the wire body 2 is fixed on the axis of the actuator 3, the internal spaces S1 and S2 of the through-hole 35 are maximized even when the internal space of the through-hole 35 is narrow, and it is thus possible to maintain or increase the number of wire bodies 2 inserted into the through-hole 35.

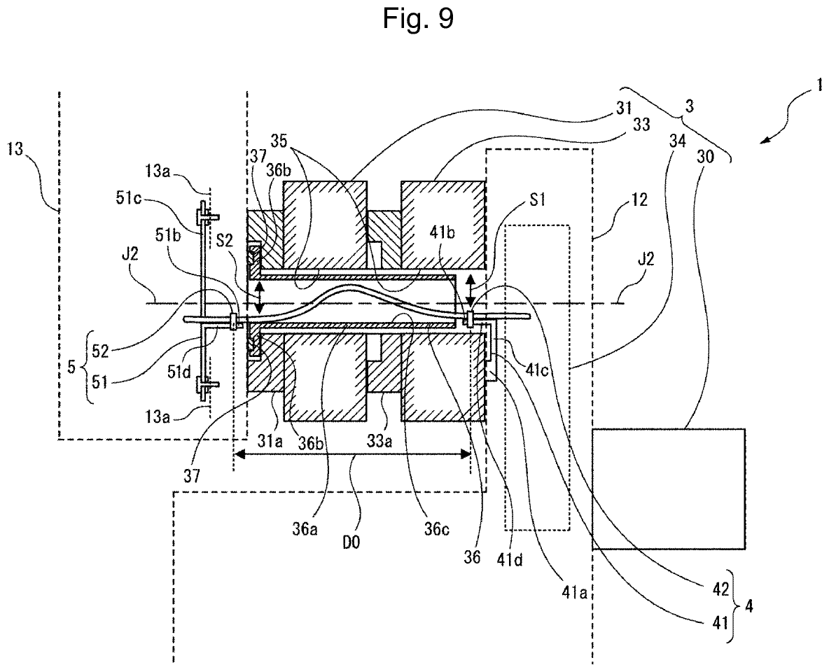

FIG. 9 is a sectional view of a wire body fixing structure 1 according to a fourth embodiment. The wire body fixing structure 1 according to the fourth embodiment is different from the wire body fixing structure 1 according to the first embodiment in that the wire body fixing structure 1 according to the fourth embodiment is an articulation structure of a robot of a second axis J2 rather than an articulation structure of a robot of a fourth axis J4. In other words, an actuator 3 according to the fourth embodiment rotates a first arm 13 about the second axis J2 relative to a swivel body 12 (first link). The actuator 3 according to the fourth embodiment does not include a sensor 32 and includes an electric motor 30, a plurality of decelerators 31 and 33, and another machine element 34. Similarly to the front decelerator 31, the rear decelerator 33 is configured with a known gear mechanism, and the machine element 34 is configured with, for example, a known chain, belt, gear mechanism, or the like. The plurality of decelerators 31 and 33 are coupled in series.

The electric motor 30 is fixed to the swivel body 12 (first link), an output shaft (not illustrated) of the electric motor 30 is coupled to the machine element 34, and the machine element 34 is coupled to an input part (not illustrated; e.g., an input gear) of the rear decelerator 33. Further, an output part 33a of the rear decelerator 33 is coupled to the input part (not illustrated; e.g., an input gear) of the front decelerator 31, and an output part 31a of the front decelerator 31 is coupled to the first arm 13 (second link). Further, a flange part 36b of a protection tube 36 is sandwiched between the output part 31a (first member) of the decelerator 31 and the first arm 13 (second member). An elastic body 37 is inserted between the flange part 36b of the protection tube 36 and the first arm 13 (second member).

Once the output shaft of the electric motor 30 rotates, the output part 33a of the rear decelerator 33 rotates while being further decelerated than the output shaft of the electric motor 30, the output part 31a of the front decelerator 31 rotates while being further decelerated than the output part 33a of the rear decelerator 33, and the output part 31a of the front decelerator 31, the protection tube 36, and the first arm 13 (second link) integrally rotate. A through-hole 35 according to the fourth embodiment passes only the plurality of decelerators 31 and 33.

The rear fixing part 4 fixes a wire body 2 between an axis (the second axis J2 in the present embodiment) of the actuator 3 and an inner circumferential surface of the through-hole 35 in the rear internal space S1 of the through-hole 35. To be more specific, the rear fixing part 4 fixes the wire body 2 at a position away from the axis (the second axis J2 in the present embodiment) of the decelerator 31 in the internal space S1 of the decelerator 31. In other words, the rear fixing part 4 fixes the wire body 2 in the internal space S1 of the through-hole 35 outside the exit of the protection tube 36.

On the other hand, since the front internal space S2 of the through-hole 35 is occupied by the protection tube 36, the front internal space S2 is narrower than the rear internal space S1 of the through-hole 35. Thus, the wire body fixing structure 1 according to the fourth embodiment is also different from the wire body fixing structure 1 according to the first embodiment in that the front fixing part 5 fixes the wire body 2 in the internal space of the first arm 13 (second link) outside the exit of the through-hole 35 rather than the internal space of the through-hole 35. To be more specific, the front fixing part 5 fixes the wire body 2 at a position away from the axis (the second axis J2 in the present embodiment) of the first arm 13 in the internal space of the first arm 13.

A support member 51 of the front fixing part 5 is fixed to the inside 13a of the first arm 13 with a fastening tool 53 such as a screw. Although the rear fixing part 4 is fixed to the actuator 3, the front fixing part 5 may not necessarily be fixed to the actuator 3. Since the front fixing part 5 is fixed to the first arm 13, the wire body fixing structure 1 according to the fourth embodiment may further include the first arm 13 (second link).

As described above, according to the wire body fixing structure 1 of the fourth embodiment, the two fixing parts 4 and 5 fix the wire body 2 at the positions away from the axis (the second axis J2 in the present embodiment) of the actuator 3 similarly to the wire body fixing structure 1 according to the first embodiment even in the articulation structure of another robot and even when the actuator 3 includes the plurality of decelerators 31 and 33 and the through-hole 35 passes through only the plurality of decelerators 31 and 33, it is thus possible to reduce twisting of the wire body 2 during an operation of the actuator as compared with a case where the wire body 2 is fixed on the axis of the actuator 3, the internal spaces S1 and S2 of the through-hole 35 are maximized even when the internal space of the through-hole 35 is narrow, and it is thus possible to maintain or increase the number of wire bodies 2 inserted into the through-hole 35.

Although various embodiments have been described in the present description, it should be recognized that the present invention is not limited to the above-described embodiments, and various modifications can be made within the scope set forth in the claims.

1. A wire body fixing structure comprising:
an actuator including a through-hole through which a wire body passes; and
a fixing part configured to fix the wire body between an axis of the actuator and an inner circumferential surface of the through-hole in an internal space of the through-hole.

2. The wire body fixing structure of claim 1, further comprising a protection tube arranged inside the through-hole and configured to protect the wire body from a power transmission element of the actuator, wherein
the fixing part fixes the wire body in the internal space of the through-hole outside an exit of the protection tube.

3. The wire body fixing structure of claim 2, wherein
the fixing part includes a support member configured to support the wire body, and
a distance from the axis of the actuator to the support member is shorter than or substantially equal to a distance from the axis to an inner circumferential surface of the protection tube.

4. The wire body fixing structure of claim 2, wherein
the fixing part includes a support member configured to support the wire body, and
a distance from a free end of the support member to an end surface of the protection tube is shorter than a thickness of the wire body or a thickness of a bundle of the wire bodies.

5. The wire body fixing structure of claim 1, wherein
the fixing part includes a support member configured to support the wire body, and
a corner, on a side close to the wire body, of the free end of the support member is rounded.

6. The wire body fixing structure of claim 1, wherein
the actuator includes only an electric motor or includes an electric motor to which at least one selected from the group of a decelerator, a sensor, and another machine element is coupled, and the fixing part fixes the wire body in an internal space of the electric motor, the decelerator, or the sensor.

7. The wire body fixing structure of claim 1, wherein two fixing parts are disposed, and at least one of the two fixing parts fixes the wire body in the internal space of the through-hole.

8. The wire body fixing structure of claim 7, wherein the two fixing parts fix the wire body at substantially same angular positions or at angular positions deviating from each other by approximately 180 degrees about the axis of the actuator at a reference position of the actuator.

9. The wire body fixing structure of claim 7, wherein
the fixing part includes a support member configured to support the wire body and an attachment tool configured to attach the wire body to the support member,
the wire body is laid loosely between two attachment tools, and
at least one selected from the group of a support surface of the support member supporting the wire body and a contact surface of the attachment tools with the wire body is smooth.

10. A machine comprising the wire body fixing structure described in claim 1.

11. A robot comprising the wire body fixing structure described in claim 1.

12. An actuator comprising the wire body fixing structure described in claim 1.
